(19) United States
(12) Patent Application Publication
(10) Pub. No.: US 2011/0239235 A1
(43) Pub. Date: Sep. 29, 2011

(54) Motor and optical disk driving device having motor

(75) Inventors: Byung Hoon Lee, Suwon (KR); Sang Kyu Lee, Suwon (KR); Dong Yeon Shin, Suwon (KR)

(73) Assignee: SAMSUNG ELECTRO-MECHANICS CO., LTD., Suwon (KR)

(21) Appl. No.: 12/926,525

(22) Filed: Nov. 23, 2010

(30) Foreign Application Priority Data
Mar. 26, 2010 (KR) 10-2010-0027381

(51) Int. Cl. G11B 17/04; H02K 7/08; G11B 17/028

(52) U.S. Cl. 720/619; 310/90; 720/703; G9B/17.013; G9B/17.006

(57) ABSTRACT

Disclosed is a motor including a rotor body mounted on a shaft and a chucking mechanism body mounted on a rotor hub, which are coupled with an increased coupling force by changing a coupling structure of the rotor hub of the rotor body and the chucking mechanism body mounted on the rotor hub. The motor includes: a sleeve rotatably supporting a shaft; a rotor body having a rotor hub mounted on the shaft; and a chucking mechanism body having a boss with a through hole in which the rotor hub is insertedly coupled and a space part formed within the boss and providing an elastic force when the rotor hub is coupled. Because a force of restitution resulting from an elastic deformation of the boss provided in the chucking mechanism body can be increased through the space part, namely, because a pressing force applied to the rotor hub of the rotor body can be increased by the boss, the coupling force between the rotor hub of the rotor body and the boss of the chucking mechanism body can be increased and, in addition, the coupling force between the rotor hub of the rotor body and the boss of the chucking mechanism body can be further increased by the release preventing unit.

### CROSS-REFERENCE TO RELATED APPLICATIONS

This application claims the priority of Korean Patent Application No. 10-2010-0027381 filed on Mar. 26, 2010, in the Korean Intellectual Property Office, the disclosure of which is incorporated herein by reference.

### BACKGROUND OF THE INVENTION

1. Field of the Invention

The present invention relates to a motor and an optical disk driving device having the motor, and more particularly, to a motor for rotatably driving a disk mounted thereon at a high speed, and an optical disk driving device having the motor.

2. Description of the Related Art

In general, a spindle motor installed within an optical disk drive serves to rotate a disk to allow an optical pick-up to mechanically read data recorded on the disk.

In the related art, the spindle motor is configured such that a rotor body is mounted on a shaft provided at a base member and a chucking mechanism body is coupled to the rotor body mounted on the shaft. In this case, the chucking mechanism body and the rotor body are coupled through shrink-fitting.

The chucking mechanism body is an injection-molded product, and in this case, in terms of the fabrication process of the injection-molded product, a great dimensional deviation of the fabricated chucking mechanism body is generated according to conditions such as temperature, humidity, and the like, within a mold.

Also, the rotor body coupled to the chucking mechanism body is fabricated through pressing and has a very small coefficient of thermal expansion in comparison to that of the chucking mechanism body, an injection-molded product.

Thus, although the chucking mechanism body and the rotor body are coupled through shrink-fitting, if the optical disk driver with the spindle motor mounted thereon is in use under conditions of extremely low temperature (e.g., a condition in which temperature is about −40° C., minus forty degrees Celsius or lower) or under conditions of extremely high temperature (e.g., a condition in which temperature is about 60° C., sixty degrees Celsius or higher), the chucking mechanism body and the rotor body would be separated due to the difference in the coefficient of thermal expansion between the chucking mechanism body and the rotor body.

### SUMMARY OF THE INVENTION

An aspect of the present invention provides a motor including a rotor body mounted on a shaft and a chucking mechanism body mounted on a rotor hub, which are coupled with an increased coupling force by changing a coupling structure of the rotor hub of the rotor body and the chucking mechanism body mounted on the rotor hub, and an optical disk driving device having the motor.

According to an aspect of the present invention, there is provided a motor including: a sleeve rotatably supporting a shaft; a rotor body having a rotor hub mounted on the shaft; and a chucking mechanism body having a boss with a through hole in which the rotor hub is insertedly coupled and a space part formed within the boss and providing an elastic force when the rotor hub is coupled.

The boss may include an elastic deformation part disposed at an inner side of the space part with respect to a circumferential direction of the shaft and elastically deformed when the rotor hub is inserted therein.

The space part may include one or a plurality of recesses formed from a lower end portion of the boss to an upper side of the shaft in an axial direction.

According to another aspect of the present invention, there is provided a motor including: a sleeve rotatably supporting a shaft; a rotor body having a rotor hub mounted on the shaft; a chucking mechanism body having a boss with a through hole in which the rotor hub is insertedly coupled; and a release preventing unit formed on at least one of the rotor hub and the boss to prevent the chucking mechanism body from being released from the rotor body.

The motor may further include: a space part formed within the boss and providing an elastic force when the rotor hub is coupled.

The space part may include one or a plurality of recesses formed from a lower end portion of the boss to an upper side of the shaft in an axial direction.

The release preventing unit may include: a stopping part formed on an outer circumferential surface of the stopping part; and a stopping correspondence part provided on the outer circumferential surface of the rotor hub or the inner circumferential surface of the boss such that the stopping correspondence part corresponds to the stopping part, and preventing the chucking mechanism body from being released in association with the stopping part.

The stopping part and the stopping correspondence part may be configured as a stopping protrusion and a stopping recess or configured as a plurality of stopping protrusions and a plurality of stopping recesses lined up in the axial direction of the shaft, and the stopping protrusion may be insertedly coupled in the stopping recess.

A plurality of stopping protrusions and a plurality of stopping recesses may be separately disposed on the same concentric circles along the outer circumferential surface of the rotor hub and the inner circumferential surface of the boss.

The rotor body may be made of a material having a lower elastic deformation rate than that of the chucking mechanism body.

According to another aspect of the present invention, there is provided a device for driving an optical disk, including: a main body housing having an opening allowing a disk to be taken in or out therethrough; a motor mounted in the main body housing, as one being among those according to the above description; an optical pick-up unit irradiating light onto the disk rotated by the motor and receiving reflected light therefrom; and a driving unit moving the optical pick-up unit in a circumferential direction of the disk.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a schematic sectional view of a motor according to an exemplary embodiment of the present invention;

FIG. 2 is an exploded perspective view of a rotor body and a chucking mechanism according to an exemplary embodiment of the present invention;

FIG. 3 is a schematic sectional view of a motor according to another exemplary embodiment of the present invention;

FIG. 4 is an exploded perspective view of a rotor body and a chucking mechanism according to another exemplary embodiment of the present invention;

FIG. 5 is a schematic sectional view of a motor according to another exemplary embodiment of the present invention;

FIG. 6 is an exploded perspective view of a rotor body and a chucking mechanism according to another exemplary embodiment of the present invention;

FIG. 7 is a schematic sectional view of a motor according to another exemplary embodiment of the present invention;

FIG. 8 is an exploded perspective view of a rotor body and a chucking mechanism according to another exemplary embodiment of the present invention;

FIG. 9 is a bottom perspective view of a chucking mechanism body according to another exemplary embodiment of the present invention;

FIG. 10 is a perspective view of a release preventing unit according to another exemplary embodiment of the present invention; and

FIG. 11 is a schematic sectional view of an optical disk driving device according to an exemplary embodiment of the present invention.

### DETAILED DESCRIPTION OF THE PREFERRED EMBODIMENT

Exemplary embodiments of the present invention will now be described in detail with reference to the accompanying drawings. The invention may, however, be embodied in many different forms and should not be construed as being limited to the embodiments set forth herein. Rather, these embodiments are provided so that this disclosure will be thorough and complete, and will fully convey the scope of the invention to those skilled in the art. In the drawings, the shapes and dimensions may be exaggerated for clarity, and the same reference numerals will be used throughout to designate the same or like components.

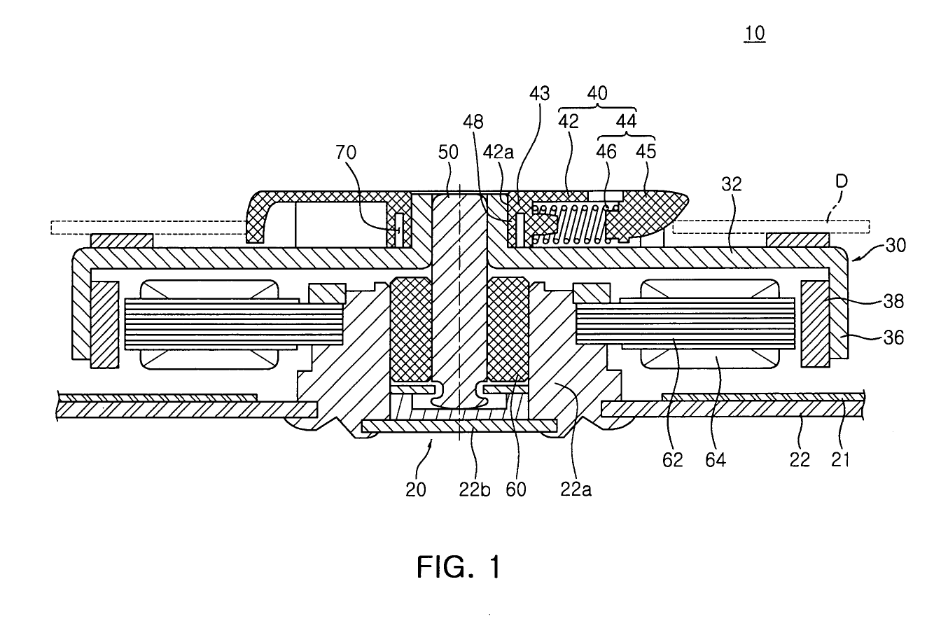

FIG. 1 is a schematic sectional view of a motor according to an exemplary embodiment of the present invention.

With reference to FIG. 1, a motor 10 according to an exemplary embodiment of the present invention includes a base member 22, a rotor body 32, and a chucking mechanism body 42.

The motor 10 may be a spindle motor applied to an optical disk driving device for rotating a disk (D), and may include a stator 20 and a rotor 30.

The stator 20 and the rotor 30 constituting the motor 10 will now be described briefly.

First, the stator 20, which refers to every fixed body excluding a rotary member, includes a base member 22 on which a printed circuit board (PCB) 21 is installed. The base member 22 may include a sleeve holder 22a in order to press-fit and support a sleeve 60.

The base member 22 also includes a plate 22b for shielding a lower end portion of the sleeve 60 against the exterior. Namely, the sleeve 60 is mounted at an upper portion of the plate 22b.

The stator 20 further includes a core 62 fixed to the sleeve holder 22a and a winding coil 64 covering the core 62.

The rotor 30 may include a rotor body 32 and a magnet 38.

The rotor body 32 includes a bent portion 36, and the annular magnet 38 corresponding to the winding coil 64 of the stator 20 is mounted on an inner circumferential surface of the bent portion 36. The magnet 38 mounted on the bent portion 36 is configured as a permanent magnet having an N pole and an S pole alternately magnetized in a circumferential direction to generate a magnetic force of a certain strength.

The rotor body 32 may include a rotor hub 34 press-fit to be fastened to the shaft 50, and the rotor hub 34 is formed to extend upward in an axial direction in order to maintain a drawing force (i.e., a pulling out force) with the shaft 50.

A chucking mechanism 40 is coupled at an upper portion of the rotor body in order to place a disk (D) thereon.

The magnet 38 provided on the inner circumferential surface of the bent portion 36 is disposed to face the winding coil 64, and the rotor 30 is rotated according to an electromagnetic interaction of the magnet 38 and the winding coil 64.

Namely, the rotor body 32 is rotated, and accordingly, the shaft 50 interlocking with the rotor body 32 is rotated.

The chucking mechanism 40 includes a chucking mechanism body 42 and a chucking body 44. The chucking unit 44 is installed within the chucking mechanism body 42.

The chucking unit 44 includes a chucking member 45 and an elastic member 46. The chucking member 45 is elastically supported in a circumferential direction of the shaft 50 by the elastic member 46. Accordingly, the chucking member 45 slidably moves to fix the disk (D).

The stator 20, the rotor 30, and the chucking mechanism 40 are elements widely known in the art, so a detailed description thereof will be omitted.

Terms with respect to directions will now be described: An axial direction refers to a vertical direction based on the shaft 50, while a circumferential direction refers to a direction toward the bent body 36 of the rotor body 32 based on the shaft 50 or a direction from the bent portion 36 of the rotor body 32 toward the shaft 50.

As described above, the sleeve 60 rotatably supports the shaft 50. Namely, the shaft 50 is press-fit to the sleeve 60 so as to be rotated.

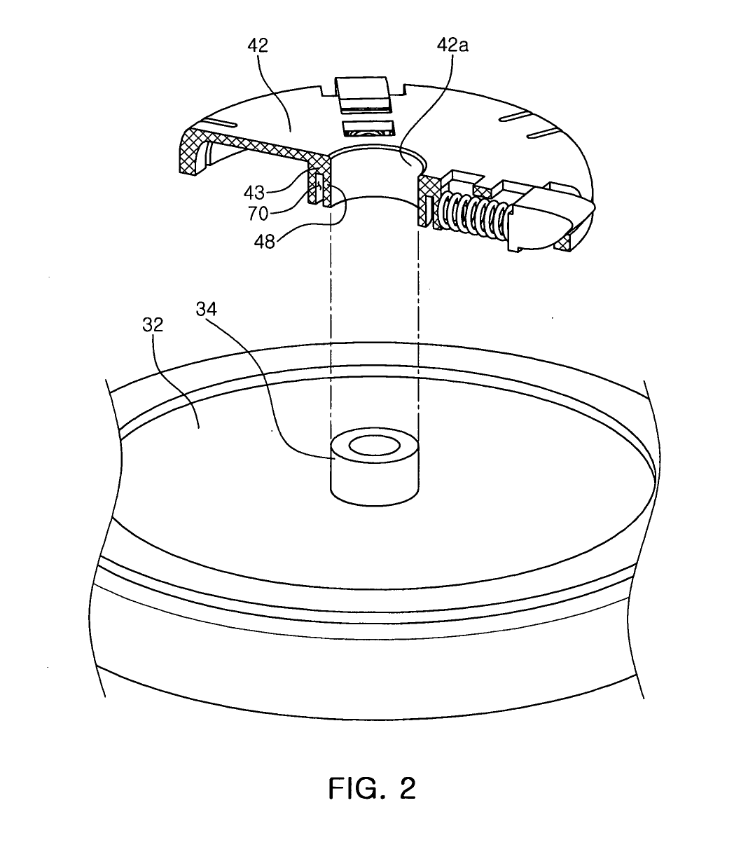

The motor according to an exemplary embodiment of the present invention will now be described with reference to FIG. 2.

FIG. 2 is an exploded perspective view of a rotor body and a chucking mechanism according to an exemplary embodiment of the present invention.

With reference to FIG. 2, the rotor body 32 includes a rotor hub 34 mounted at an upper end portion of the shaft 50. The rotor hub 34 may be formed to have a shape corresponding to the shape of the shaft 50.

Namely, the rotor hub 34 may have a cylindrical shape to allow the shaft 50 to be insertedly mounted therein, and may be press-fit to the shaft 50. Accordingly, the rotor body 32 and the shaft 50 can be rotated cooperatively.

Meanwhile, the chucking mechanism body 42 includes a boss 43 with a through hole 42a in which the rotor hub 34 is insertedly coupled, and a space part 70 formed within the boss 43 and providing an elastic force when the rotor hub 34 is coupled.

Namely, the space part 70 may be disposed around the through hole 43a in the circumferential surface of the shaft 50 such that the boss 43 can be press-fit to the rotor hub 34.

The space part 70 may be configured as a single recess at a lower end portion of the boss 43 toward the upper portion of the shaft 50 in the axial direction. Namely, the space part 70 may be configured as a recess disposed to be parallel to the through hole 42a in the axial direction of the shaft 50.

The boss 43 includes an elastic deformation part 48 disposed at an inner side of the space part 70 in the circumferential direction of the shaft 50 and elastically deformed when the rotor hub 34 is inserted. When the elastic deformation part 48 is mounted to the rotor hub 34, it is pressurized by the rotor hub 34 so as to be elastically deformed toward the space part 70, and accordingly, a force of restitution is generated from the elastic deformation part 48 toward the center of the shaft 50.

Accordingly, when the rotor hub 34 of the rotor body 32 is press-fit to the through hole 42a of the boss 43, the rotor hub 34 and the upper portion of the boss 43 are fixedly coupled through shrink-fitting, and in addition, the rotor hub 34 and a lower portion of the boss 43 are coupled in a state of being pressurized by the elastic deformation part 48 of the boss 43.

As a result, the coupling force between the chucking mechanism body 42 and the rotor body 32 is increased to prevent the chucking mechanism body 42 from being released from the rotor body 32 even under an extremely low temperature condition or an extremely high temperature condition.

Also, the rotor body 32 may be made of a material having a lower elastic deformation rate than that of the chucking mechanism body 42. Namely, the rotor body 32 may be made of, for example, a metal material, and the chucking mechanism body 42 may be made of a synthetic resin material. Thus, the boss 43 can be press-fit to the rotor hub 34.

A motor according to another exemplary embodiment of the present invention will now be described with reference to the accompanying drawings.

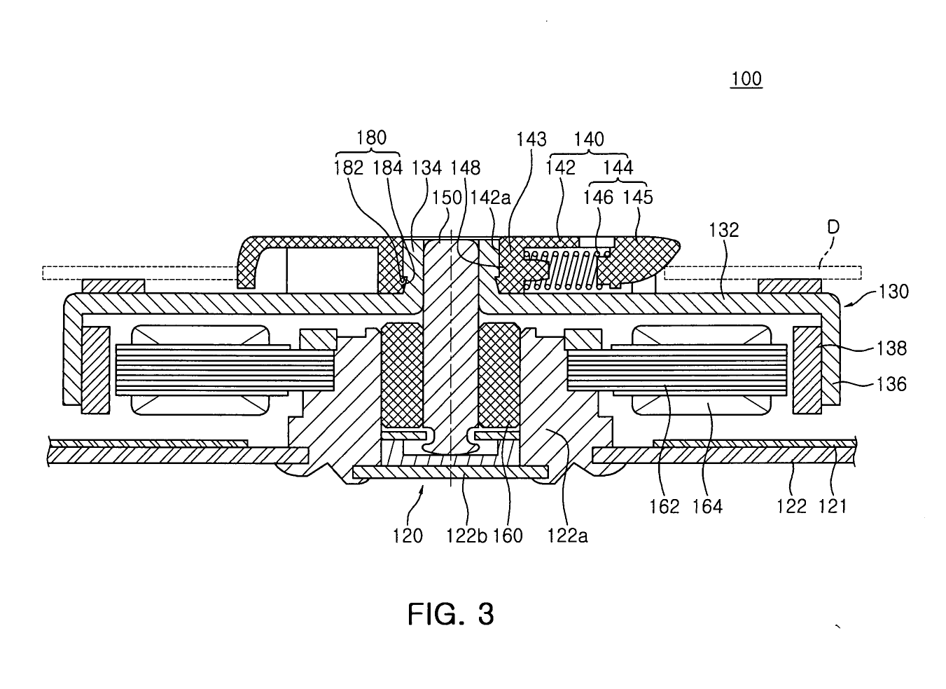

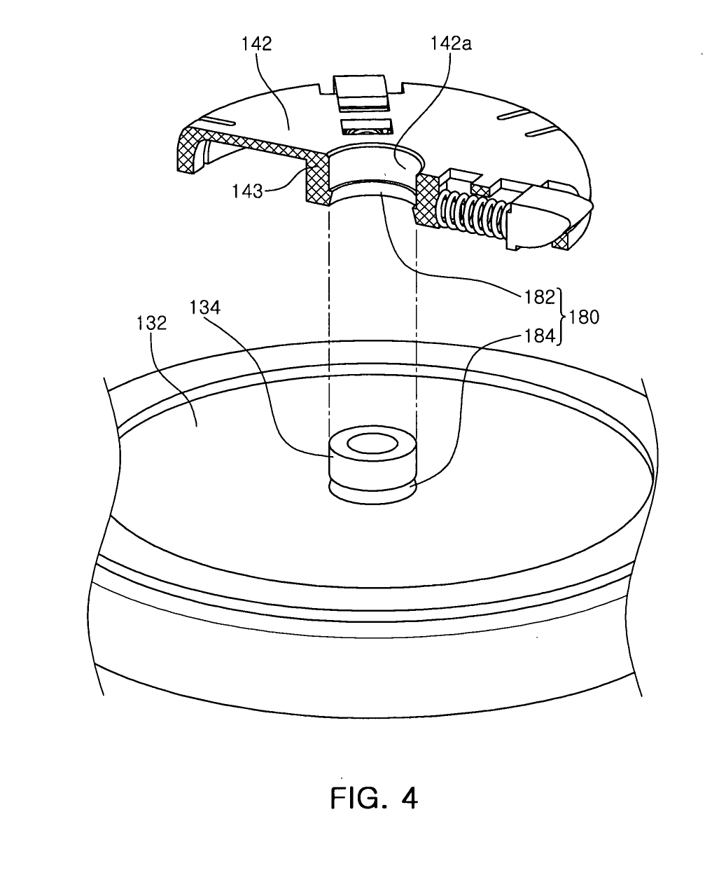

FIG. 3 is a schematic sectional view of a motor according to another exemplary embodiment of the present invention, and FIG. 4 is an exploded perspective view of a rotor body and a chucking mechanism according to another exemplary embodiment of the present invention.

With reference to FIGS. 3 and 4, a motor 110 according to another exemplary embodiment of the present invention includes a sleeve 160, a rotor body 132, a chucking mechanism body 142, and a release preventing unit 180.

The sleeve 160 rotatably supports a shaft 150. Namely, the shaft 150 is press-fit to the sleeve 160 so as to be rotated.

Meanwhile, the rotor body 132 includes a rotor hub 134 mounted at an upper end portion of the shaft 150. The rotor hub 134 may be formed to have a shape corresponding to that of the shaft 150.

Namely, the rotor hub 134 may have a cylindrical shape to allow the shaft 150 to be insertedly mounted therein, and may be press-fit to the shaft 150. Accordingly, the rotor body 132 and the shaft 150 can be rotated cooperatively.

Meanwhile, the chucking mechanism body 142 may include a boss 143 with a through hole 142a in which the rotor hub 134 is insertedly coupled.

Also, the chucking mechanism body 142 may be made of a material having a smaller elastic deformation rate than that of the rotor body 132 so as to be shrink-fit with the rotor body 132. Namely, the chucking mechanism body 142 may be made of a synthetic resin material, and the rotor body 132 may be made of a metal material.

Accordingly, when the rotor hub 134 of the rotor body 132 is insertedly coupled in the through hole 142a of the boss 143, it can be coupled through shrink fitting.

Meanwhile, the release preventing unit 180 is formed on at least one of the rotor hub 134 and the boss 143 to prevent the chucking mechanism body 142 from being released from the rotor body 132.

The release preventing unit 180 may include a stopping part 182 and a stopping correspondence part 184. The stopping part 182 may be, for example, a stopping protrusion formed on an inner surface of the boss 143 as shown in FIG. 4.

The stopping correspondence part 184, which corresponds to the stopping part 182, may be, for example, a stopping recess formed on an outer circumferential surface of the rotor hub 134 as shown in FIG. 4.

Namely, the stopping part 182 is insertedly coupled to the stopping correspondence part 184 to prevent the rotor hub 134 of the rotor body 132 and the boss 143 of the chucking mechanism body 142 from being released.

The shapes of the stopping part 182 and the stopping correspondence part 184 are not limited to those illustrated in FIG. 4, and any shape can be employed so long as the stopping part 182 is insertedly coupled to the stopping correspondence part 184.

In the present exemplary embodiment, the stopping part 182 is formed on the boss 143 and the stopping correspondence part 184 is formed on the rotor hub 134, but the present invention is not limited thereto and the stopping part 182 may be formed on the rotor hub 134 and the stopping correspondence part 184 may be formed on the boss 143.

When the chucking mechanism body 142 and the rotor body 132 are coupled, the stopping part 182 extends according to an elastic deformation of the boss 143, and thereafter, as the boss 143 is restored to its original position, the stopping part 182 is insertedly coupled to the stopping correspondence part 184.

The stopping part 182 and the stopping correspondence part 184 may have an annular shape to correspond to the rotor hub 134 and the boss 143 as shown in FIG. 4.

In this manner, the coupling force between the rotor body 132 and the chucking mechanism body 142 can be increased by virtue of the release preventing unit 180 formed on the rotor hub 134 of the rotor body 132 and formed on the boss 143 of the chucking mechanism body 142.

Accordingly, because the boss 143 of the chucking mechanism body 142 is prevented from being released from the rotor hub 134 of the rotor body 132 under conditions of extremely low temperature or extremely high temperature, separation of the rotor body 132 and the chucking mechanism body 142 can be prevented.

A motor according to another exemplary embodiment of the present invention will now be described with reference to the accompanying drawings.

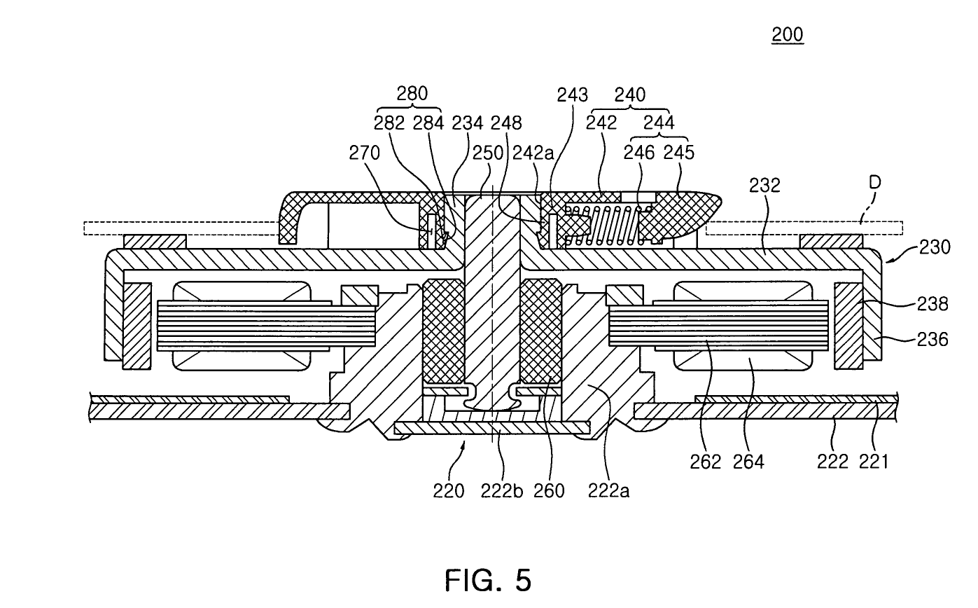

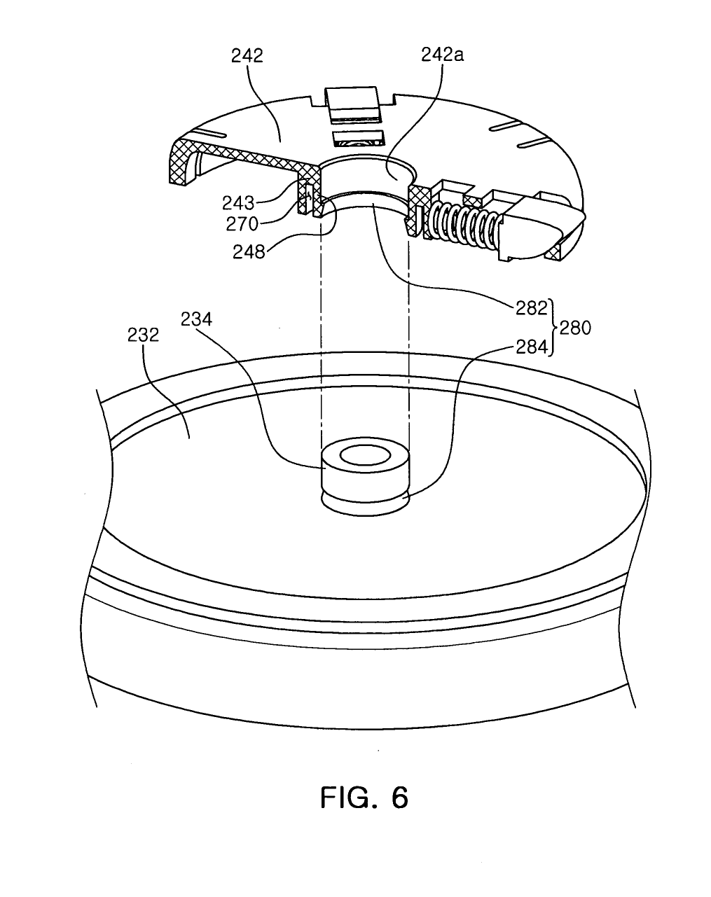

FIG. 5 is a schematic sectional view of a motor according to another exemplary embodiment of the present invention, and FIG. 6 is an exploded perspective view of a rotor body and a chucking mechanism according to another exemplary embodiment of the present invention.

With reference to FIGS. 5 and 6, a motor 210 according to another exemplary embodiment of the present invention includes a sleeve 260, a rotor body 232, a chucking mechanism body 242, and a release preventing unit 280.

The sleeve 260 rotatably supports a shaft 250. Namely, the shaft 250 is press-fit to the sleeve 260 so as to be rotated.

The rotor body 232 includes a rotor hub 234 mounted at an upper end portion of the shaft 250. The rotor hub 234 may be formed to have a shape corresponding to that of the shaft 250.

Namely, the rotor hub 234 may have a cylindrical shape to allow the shaft 250 to be insertedly mounted therein, and may be press-fit to the shaft 250. Accordingly, the rotor body 232 and the shaft 250 can be rotated cooperatively.

Meanwhile, the chucking mechanism body 242 may include a boss 243 with a through hole 242a in which the rotor hub 234 is insertedly coupled, and a space part 270 formed within the boss 243 and providing an elastic force when the rotor hub 234 is coupled.

Namely, the space part 270 may be disposed around the through hole 243a in the circumferential surface of the shaft 250 such that the boss 243 can be press-fit to the rotor hub 234.

The space part 270 may be configured as a single recess at a lower end portion of the boss 243 toward the upper portion of the shaft 250 in the axial direction. Namely, the space part 270 may be configured as a recess disposed to be parallel to the through hole 242a in the axial direction of the shaft 250.

The boss 243 includes an elastic deformation part 248 disposed at an inner side of the space part 270 in the circumferential direction of the shaft 250 and elastically deformed when the rotor hub 234 is inserted. When the elastic deformation part 248 is mounted to the rotor hub 234, it is pressurized by the rotor hub 234 so as to be elastically deformed toward the space part 270, and accordingly, a force of restitution is generated from the elastic deformation part 248 toward the center of the shaft 250.

Accordingly, when the rotor hub 234 of the rotor body 232 is press-fit to the through hole 242a of the boss 243, the rotor hub 234 and the upper portion of the boss 243 are fixedly coupled through shrink-fitting, and in addition, the rotor hub 234 and a lower portion of the boss 243 are coupled in a state of being pressurized by the elastic deformation part 248 of the boss 243.

As a result, the coupling force between the chucking mechanism body 242 and the rotor body 232 is increased to prevent the chucking mechanism body 242 from being released from the rotor body 232 even under an extremely low temperature condition or an extremely high temperature condition.

Also, the rotor body 232 may be made of a material having a lower elastic deformation rate than that of the chucking mechanism body 242. Namely, the rotor body 232 may be made of, for example, a metal material, and the chucking mechanism body 242 may be made of a synthetic resin material. Thus, the boss 243 can be press-fit to the rotor hub 234.

Meanwhile, the motor 210 according to an exemplary embodiment of the present invention may further include a release preventing unit 280 formed on at least one of the rotor hub 234 and the boss 242 to prevent the chucking mechanism body 242 from being released from the rotor body 232.

The release preventing unit 280 may include a stopping part 282 and a stopping correspondence part 284. The stopping part 282 may be, for example, a stopping protrusion formed on an inner surface of the boss 243 as shown in FIG. 5.

The stopping correspondence part 284, which corresponds to the stopping part 282, may be, for example, a stopping recess formed on an outer circumferential surface of the rotor hub 234 as shown in FIG. 6.

Namely, the stopping part 282 is insertedly coupled to the stopping correspondence part 284 to prevent the rotor hub 234 of the rotor body 232 and the boss 243 of the chucking mechanism body 242 from being released.

The shapes of the stopping part 282 and the stopping correspondence part 284 are not limited to those illustrated in FIGS. 5 and 6, and any shape can be employed so long as the stopping part 282 is insertedly coupled to the stopping correspondence part 284.

In the present exemplar embodiment, the stopping part 282 is formed on the boss 243 and the stopping correspondence part 284 is formed on the rotor hub 234, but the present invention is not limited thereto and the stopping part 282 may be formed on the rotor hub 234 and the stopping correspondence part 284 may be formed on the boss 243.

The stopping part 282 may be formed to be disposed on the elastic deformation part 248, and accordingly, the stopping part 282 extends according to the elastic deformation of the elastic deformation part 248, and thereafter, as the elastic deformation part 248 is restored to its original position, the stopping part 282 is insertedly coupled to the stopping correspondence part 284.

The stopping part 282 and the stopping correspondence part 284 may have an annular shape to correspond to the rotor hub 234 and the boss 243 as shown in FIG. 6.

In this manner, the coupling force between the rotor body 232 and the chucking mechanism body 242 can be increased by virtue of the release preventing unit 280 formed on the rotor hub 234 of the rotor body 232 and formed on the boss 243 of the chucking mechanism body 242.

Accordingly, because the boss 243 of the chucking mechanism body 242 is prevented from being released from the rotor hub 234 of the rotor body 232 under conditions of extremely low temperature or extremely high temperature, separation of the rotor body 232 and the chucking mechanism body 242 can be prevented.

A motor according to another exemplary embodiment of the present invention will now be described with reference to the accompanying drawings.

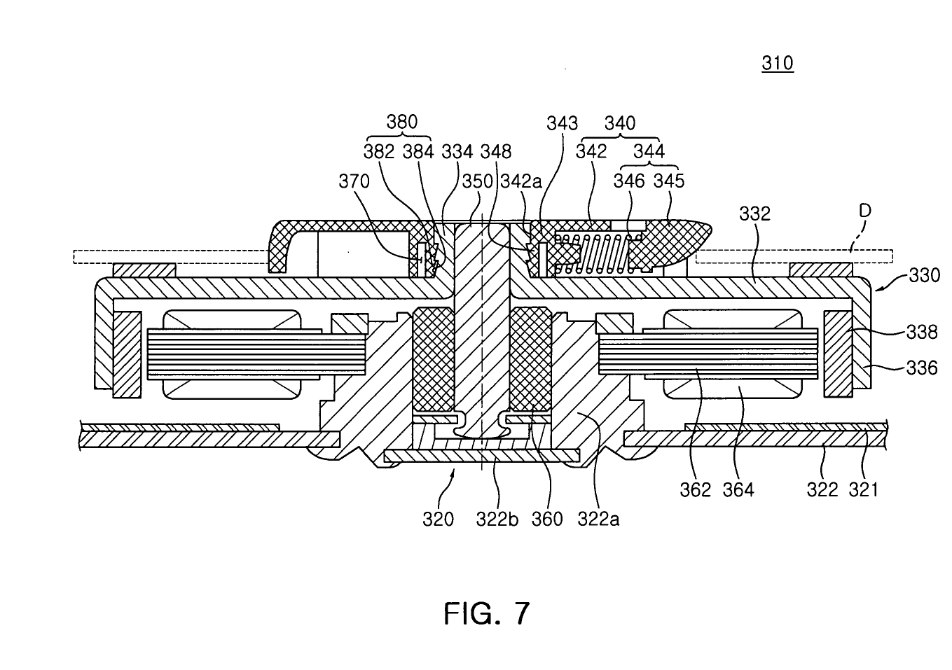

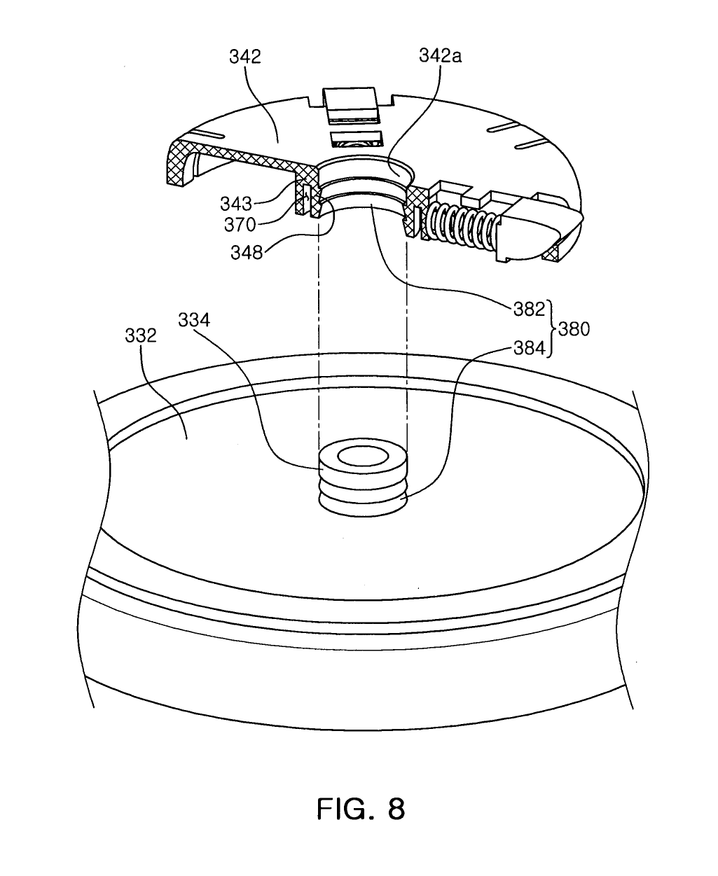

FIG. 7 is a schematic sectional view of a motor according to another exemplary embodiment of the present invention, and FIG. 8 is an exploded perspective view of a rotor body and a chucking mechanism according to another exemplary embodiment of the present invention.

A motor 310 according to another exemplary embodiment of the present invention includes the same elements as those of the motor 210 according to the former exemplary embodiment and a release preventing unit 380 modified from the release preventing unit 280 according to the former exemplary embodiment.

Namely, a sleeve 360, a rotor body 332, and a chucking mechanism body 342 provided in the motor 310 are configured in the same manner as the sleeve 260, the rotor body 232, and the chucking mechanism body 242 of the motor 210 according to an exemplary embodiment of the present invention as described above, so a detailed description thereof will be omitted.

Hereinafter, the release preventing unit 380, a modified element, will now be described.

With reference to FIGS. 7 and 8, the release preventing unit 380 may include a stopping part 382 and a stopping correspondence part 384. The stopping part 382 may be, for example, a stopping protrusion formed on an inner surface of the boss 243 as shown in FIG. 8.

The stopping correspondence part 384, which corresponds to the stopping part 282, may be, for example, a stopping recess formed on an outer circumferential surface of the rotor hub 334 as shown in FIG. 8.

Namely, the stopping part 382 is insertedly coupled to the stopping correspondence part 384 to prevent the rotor hub 334 of the rotor body 332 and the boss 343 of the chucking mechanism body 342 from being released.

In the present exemplary embodiment, a plurality of stopping parts 382 and a plurality of stopping correspondence parts 384 may be lined up in the axial direction of the shaft 350. Namely, the stopping part 282 and the stopping correspondence part 284 provided in the motor 210 according to the former exemplary embodiment as described above are solely formed, respectively, but in the present exemplary embodiment, the plurality of stopping parts 382 and a plurality of stopping correspondence parts 384 are lined up, further increasing the coupling force between the rotor body 332 and the chucking mechanism body 342.

The shapes of the stopping part 382 and the stopping correspondence part 384 are not limited to those illustrated in FIG. 8, and any shape can be employed so long as the stopping part 382 is insertedly coupled to the stopping correspondence part 384.

In the present exemplary embodiment, the stopping part 382 is formed on the boss 343 and the stopping correspondence part 384 is formed on the rotor hub 334, but the present invention is not limited thereto and the stopping part 382 may be formed on the rotor hub 334 and the stopping correspondence part 384 may be formed on the boss 343.

The stopping part 382 and the stopping correspondence part 384 may have an annular shape to correspond to the rotor hub 334 and the boss 343 as shown in FIG. 8.

However, the stopping part 382 and the stopping correspondence part 384 are not limited thereto, and a plurality of stopping parts and a plurality of stopping correspondence parts may be separately disposed on the same concentric circles along the outer circumferential surface of the rotor hub 334 and the inner circumferential surface of the boss 343.

In this manner, the coupling force between the rotor body 332 and the chucking mechanism body 342 can be increased by virtue of the release preventing unit 380 formed on the rotor hub 334 of the rotor body 332 and formed on the boss 343 of the chucking mechanism body 342.

Accordingly, because the boss 343 of the chucking mechanism body 342 is prevented from being released from the rotor hub 334 of the rotor body 332 under conditions of extremely low temperature or extremely high temperature, separation of the rotor body 332 and the chucking mechanism body 342 can be prevented.

A chucking mechanism body according to another exemplary embodiment of the present invention will now be described with reference to the accompanying drawings.

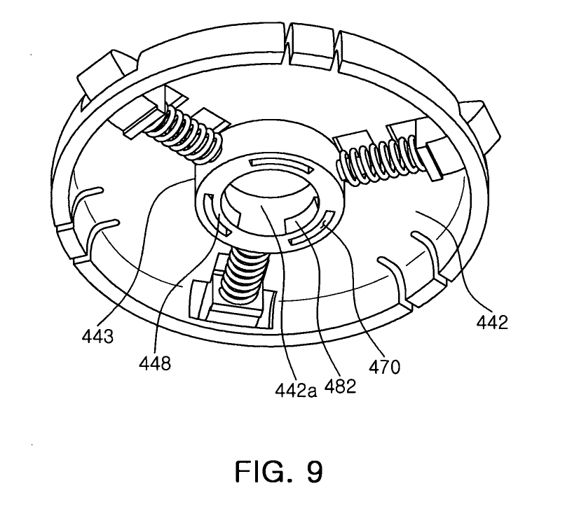

FIG. 9 is a perspective view is a bottom perspective view of a chucking mechanism body according to another exemplary embodiment of the present invention.

A motor employing a chucking mechanism body in the present exemplary embodiment is configured to include the same elements as the motors 10, 210, and 310, and only a space part 470 of the chucking mechanism body is modified from the space parts 270 and 370 in the former exemplary embodiments.

With reference to FIG. 9, the space part 470 includes a plurality of recesses formed at a lower end portion of the boss 443 upward in the axial direction of the shaft 50 (See FIG. 1). Namely, the boss 443 may include the space part 470 having a plurality of recesses formed at certain intervals.

Accordingly, the lower end portion of the boss 443 where the space part 470 is formed pressurizes the rotor hub 34 (See FIG. 1) by a force of restitution of the space part, while the lower end portion of the boss 443 where the space 470 is not formed is maintained in a press-fit state.

As a result, because the space part 470 is provided to the boss 443, the rotor hub 34 can be pressurized by the force of restitution of the space part 470, so the coupling force between the boss 443 and the rotor hub 34 can be increased.

Meanwhile, in the present exemplary embodiment, the space part 470 includes three recesses, but the present invention is not limited thereto and the space part 470 may include two recesses or four or more recesses.

A release preventing unit according to another exemplary embodiment of the present invention will now be described with reference to the accompanying drawings.

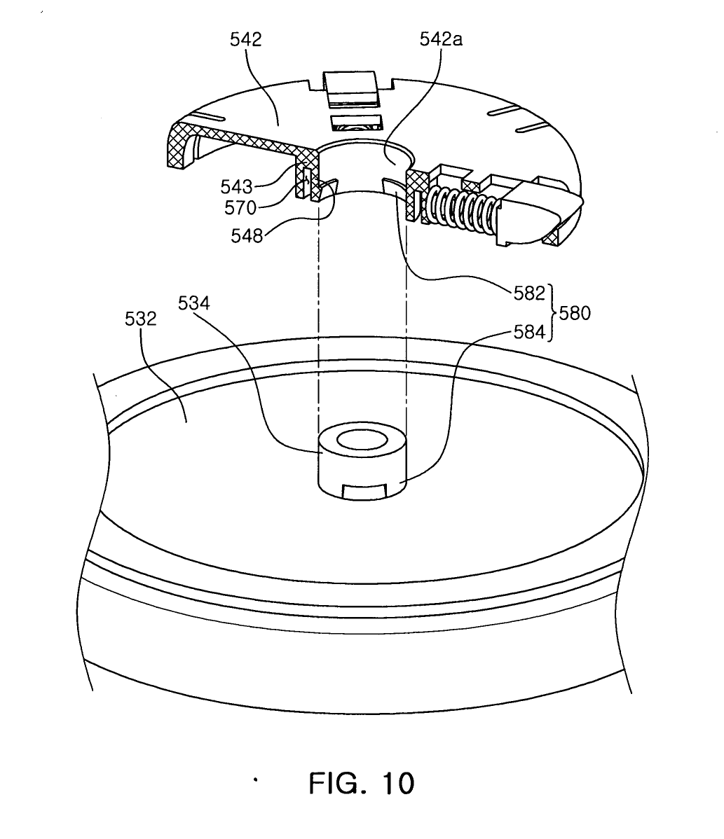

FIG. 10 is a perspective view of a release preventing unit according to another exemplary embodiment of the present invention.

A release preventing part 580 may be employed for the motors 110, 210, and 310 in the foregoing embodiments. Namely, the release preventing units 180, 280, and 380 in the foregoing embodiments have the annular shape, while, in the present exemplary embodiment, a plurality of release preventing parts 580 are separately disposed within the same concentric circles along the outer circumferential surface of the rotor hub 534 and the inner circumferential surface of the boss 543.

Accordingly, a stopping part 582 and a stopping correspondence part 584 of the release preventing parts 580 can be more easily coupled.

An optical disk driving device according to an exemplary embodiment of the present invention will now be described with reference to the accompanying drawings.

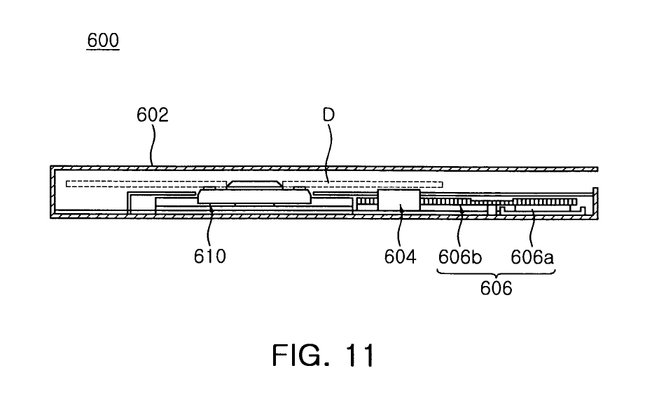

FIG. 11 is a schematic sectional view of an optical disk driving device according to an exemplary embodiment of the present invention.

As shown in FIG. 11, an optical disk driving device 600 according to an exemplary embodiment of the present invention includes a motor 610 having the entirety of the foregoing technical characteristics.

The optical disk driving device 600 according to an exemplary embodiment of the present invention includes a housing 602, an optical pick-up unit 604, and a driving unit 606.

The housing 602 includes an opening through which a disk is placed in or taken out, and has an internal space in which the motor 610, the optical pick-up unit 604, and the driving unit 606.

Meanwhile, the base member 22 (See FIG. 1) including the printed circuit board (PCB) 21 (See FIG. 1) on which the motor 610 is mounted may be fixed in the housing 602.

The optical pick-up unit 604 irradiates light onto the disk (D) rotated by the motor 610 and receives reflected light therefrom. Namely, the optical pick-up unit 604 may be installed in the housing 602 such that it is disposed under the disk (D) in order to implement a write scribing function of printing characters, drawings, or the like, on the disk (D).

Also, the driving unit 606, connected to the optical pick-up unit 604, moves the optical pick-up unit 604 in a circumferential direction of the disk (D).

The driving unit 606 delivers power generated from a motor 606a to the optical pick-up unit 604 through a power transmission member 606b, and accordingly, the optical pick-up unit 604, moving in the circumferential direction of the disk (D), irradiates light onto the disk (D) and receives reflected light therefrom.

The motor 610 has been described in detail in the former embodiments, so a detailed description thereof will be omitted.

As set forth above, according to exemplary embodiments of the invention, because a force of restitution resulting from an elastic deformation of the boss provided in the chucking mechanism body can be increased through the space part, namely, because a pressing force applied to the rotor hub of the rotor body can be increased by the boss, the coupling force between the rotor hub of the rotor body and the boss of the chucking mechanism body can be increased.

In addition, the coupling force between the rotor hub of the rotor body and the boss of the chucking mechanism body can be further increased by the release preventing unit.

While the present invention has been shown and described in connection with the exemplary embodiments, it will be apparent to those skilled in the art that modifications and variations can be made without departing from the spirit and scope of the invention as defined by the appended claims.

What is claimed is:

1. A motor comprising:
a sleeve rotatably supporting a shaft;
a rotor body having a rotor hub mounted on the shaft; and
a chucking mechanism body having a boss with a through hole in which the rotor hub is insertedly coupled and a space part formed within the boss and providing an elastic force when the rotor hub is coupled.

2. The motor of claim 1, wherein the boss comprises an elastic deformation part disposed at an inner side of the space part with respect to a circumferential direction of the shaft and elastically deformed when the rotor hub is inserted therein.

3. The motor of claim 1, wherein the space part comprises one or a plurality of recesses formed from a lower end portion of the boss to an upper side of the shaft in an axial direction.

4. A motor comprising:
a sleeve rotatably supporting a shaft;
a rotor body having a rotor hub mounted on the shaft;
a chucking mechanism body having a boss with a through hole in which the rotor hub is insertedly coupled; and
a release preventing unit formed on at least one of the rotor hub and the boss to prevent the chucking mechanism body from being released from the rotor body.

5. The motor of claim 4, wherein the motor further comprises:
a space part formed within the boss and providing an elastic force when the rotor hub is coupled.

6. The motor of claim 5, wherein the space part comprises one or a plurality of recesses formed from a lower end portion of the boss to an upper side of the shaft in an axial direction.

7. The motor of claim 4, wherein the release preventing unit comprises:
a stopping part formed on an outer circumferential surface of the stopping part; and
a stopping correspondence part provided on the outer circumferential surface of the rotor hub or the inner circumferential surface of the boss such that the stopping correspondence part corresponds to the stopping part, and preventing the chucking mechanism body from being released in association with the stopping part.

8. The motor of claim 7, wherein the stopping part and the stopping correspondence part is configured as a stopping protrusion and a stopping recess or configured as a plurality of stopping protrusions and a plurality of stopping recesses lined up in the axial direction of the shaft, and the stopping protrusion is insertedly coupled in the stopping recess.

9. The motor of claim 8, wherein a plurality of stopping protrusions and a plurality of stopping recesses are separately disposed on the same concentric circles along the outer circumferential surface of the rotor hub and the inner circumferential surface of the boss.

10. The motor of claim 1, wherein the rotor body is made of a material having a lower elastic deformation rate than that of the chucking mechanism body.

11. An optical disk driving device, comprising:
a main body housing having an opening allowing a disk to be taken in or out therethrough;
a motor mounted in the main body housing according to claim 1;
an optical pick-up unit irradiating light onto the disk rotated by the motor and receiving reflected light therefrom; and
a driving unit moving the optical pick-up unit in a circumferential direction of the disk.
